(19) United States
(12) Patent Application Publication
(10) Pub. No.: US 2008/0101176 A1
(43) Pub. Date: May 1, 2008

(54) Optical Disc Device

(75) Inventors: Hiroki Mouri, Osaka (JP); Hiroyuki Nakahira, Kyoto (JP); Kouichi Nagano, Osaka (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Osaka (JP)

(21) Appl. No.: 11/794,228

(22) PCT Filed: Oct. 20, 2005
(86) PCT No.: PCT/JP05/19292

§ 371 Date: Jun. 26, 2007

(30) Foreign Application Priority Data
Dec. 28, 2004 (JP) 2004-380646

(51) Int. Cl. G11B 7/00

(52) U.S. Cl. 369/47.5

(57) ABSTRACT

There has been an issue that the operation of a semiconductor circuit performing edge timing control cannot follow up in the multipulse generation process where high multiplication of speed progresses every year. A light strategy drive comprises a control register (22) storing timing edge information for generating the edge of a recording waveform signal, a PLL (23) generating a clock for generating the edge of a recording waveform signal, and a timing control circuit (24) for receiving timing edge information corresponding to the recording waveform signal from the control register (22) to output timing edge information having a predetermined amount of delay in parallel and compounding the edges based on the timing edge information outputted in parallel. Timing edge can be controlled with high precision even at the time of high speed operation, and a high precision multipulse can be generated.

### TECHNICAL FIELD

The present invention relates to an optical disc device and, more particularly, to an optical disc device which accurately writes digital data into an optical disc recording medium.

### BACKGROUND ART

In recent years, storage devices in which digital data are recorded, such as magnetic recording devices, optical disc storage devices, and semiconductor memory storage devices, have been widely utilized, and the recording density as well as the recording speed have been increasing year by year. When writing digital data into an optical disc recording medium, a fundamental principle is a method of performing ON/OFF control such that laser irradiation is carried out when the data is “1” while laser irradiation is not carried out when the data is “0”. However, there is a problem that high-density recording is difficult and favorable pits cannot be formed by merely turning ON and OFF laser irradiation according to “0” and “1”. So, a technique of dividing recording power to generate a multipulse and controlling the same, which is called “write strategy”, is becoming indispensable (for example, refer to patent Documents 1˜3). The write strategy denotes a recording compensation technique for accurately recording pits on an optical disc. Without the recording compensation, the pits undesirably have runny-eye shapes and thereby favorable pit formation cannot be carried out, leading to data reading errors. Accordingly, the write strategy is an indispensable technique when writing data in an optical disc.

FIG. 11 is a timing chart illustrating time edge information according to a conventional system.

As a conventional technique for generating a multipulse, plural timers each outputting timing edge information are provided, the respective timers are operated using a sequencer to generate plural timing edges, and the timing edges are synthesized to generate a multipulse.

A delay amount of the timing edge in each timer and a current value as a power amount for driving a laser diode driver are determined on the basis of a count value that is counted by a space/mark length counter unit which counts a space length and a mark length in an inputted digital signal sequence (NRZI data). Thereby, the timing edge information that is synchronized with a clock in each timer is delayed by a predetermined amount. The outputs of the timing edge information from the respective timers are controlled by the sequencer that determines the order of operating the respective timers, and timing edges are generated on the basis of the information from the respective timers, and these edges are synthesized to generate a multipulse. For example, as shown in FIG. 11, TSFP (Timing for Start of First Pulse) indicating timing information of a first rising edge of a mark is outputted from Timer 1 under control of the sequencer, and next, TEFP (Timing for End of First Pulse) indicating timing information of a first falling edge of the mark is outputted from Timer 2 under control of the sequencer, and these pulses are synthesized. Thereafter, pulses up to TELP (Timing for End of Last Pulse) indicating a last falling edge of the mark are outputted from the respective timers according to the output of the sequencer, and these timing edge informations are synthesized, thereby generating edges having predetermined current values.

Patent Document 1: Japanese Published Patent Application No. Hei. 11-283249

Patent Document 2: Japanese Published Patent Application No. 2003-187442

Patent Document 3: Japanese Published Patent Application No. Hei. 2-94113

However, the shape of the recording signal waveform varies depending on the corresponding media or speeding-up, and generation of a multipulse waveform as a recording signal waveform becomes more difficult with an increase in the speed, resulting in various problems. For example, waveform control for high-density mark formation is complicated, and increase in the number of levels of laser to be switched or subdivision of pulses proceeds, leading to the necessity of switching over plural levels at high speed. In FIG. 11, when the timer-controlled edge information is observed after the respective timers are selected by the sequencer, there occurs a period 110 in which two edges are generated in one clock section. For example, when performing high-speed operation such as 500 MHz (2 ns), two edges must be generated within a half of the clock section, i.e., 1 ns. In this case, the operation of the semiconductor circuit cannot keep up with the edge generation.

The present invention is made to solve the above-described problems and has for its object to provide an optical disc device which can accurately control timing edges to generate an accurate multipulse even during high-speed operation.

### MEASURES TO SOLVE THE PROBLEMS

In order to solve the above-described problems, according to claim 1 of the present invention, there is provided an optical disc device including a laser power control unit which controls power of laser for recording a digital signal sequence on a recording medium, a write strategy unit which divides the recording power and generates a multipulse for accurate pit formation, and a laser diode driver which emits laser according to the multipulse from the write strategy unit, and generating a recording waveform signal having edges and amplitudes corresponding to the digital signal sequence, wherein the write strategy unit comprises a storage unit for storing timing edge informations to be used for generation of edges of the recording waveform signal, a clock generation circuit for generating a clock for generating edges of the recording waveform signal, and a timing control circuit for receiving the timing edge informations corresponding to the recording waveform signal from the storage unit, processing the inputted timing edge informations in parallel, generating edges on the basis of the parallel-processed timing edge informations, and synthesizing the generated edges.

According to claim 2 of the present invention, in the optical disc device defined in claim 1, the timing control circuit comprises a space/mark length counter unit for receiving the digital signal sequence, and counting a space length and a mark length of the digital signal sequence, a timing sequencer unit for making the storage unit successively output desired timing edge informations on the basis of count values that are counted by the space/mark length counter unit, a timer unit for controlling a delay amount of the clock on the basis of the timing edge informations outputted from the storage unit, and outputting time edge informations having a predetermined delay amount, a parallel processing sequencer for controlling the outputting of the timing edge informations from the timer unit so that the timing edge informations are outputted in parallel, and a parallel processing circuit for generating edges in parallel on the basis of the parallel-outputted timing edge informations under control of the parallel processing sequencer, and synthesizing the generated edges.

According to claim 3 of the present invention, in the optical disc device defined in claim 2, the storage unit includes one or plural tables each having a plurality of the timing edge informations, the timing edge informations include address informations corresponding to the count values counted by the space/mark length counter unit, and each table includes table address information corresponding to the table.

According to claim 4 of the present invention, in the optical disc device defined in claim 3, the timing sequencer unit controls the outputting of the timing edge informations on the basis of the count values outputted from the space/mark length counter unit, with reference to the table in which the timing edge informations corresponding to the count values are stored.

According to claim 5 of the present invention, in the optical disc device defined in claim 2, the space/mark length counter unit performs a clipping process and outputs a maximum value that has previously been set, when the count value exceeds a predetermined value.

According to claim 6 of the present invention, in the optical disc device defined in claim 2, the timing edge informations stored in the storage unit include at least plural fixed current values, and the recording waveform generated in the parallel processing circuit is a recording waveform a current value of which is selected from among the plural fixed current values stored in the storage unit, according to the mark length and the space length in the section of the mark length.

According to claim 7 of the present invention, in the optical disc device defined in claim 2, the recording waveform to be generated in the parallel processing circuit has a period for outputting a constant current value to the laser diode driver, between a mark length and a mark length.

According to claim 8 of the present invention, in the optical disc device defined in claim 2, the timing edge informations inputted to the timer unit include at least delay amounts and current amounts.

According to claim 9 of the present invention, in the optical disc device defined in claim 8, the timer unit comprises a plurality of first selectors for parallel outputting the outputs of the timing edge informations having predetermined delay amount values, under selective control of the parallel processing sequencer, and a plurality of second selectors for parallel outputting the outputs of the timing edge informations having predetermined current values, under selective control of the parallel processing sequencer; the parallel processing circuit comprises an RS latch circuit which receives the timing edge informations outputted from the respective first selectors, as a data set signal and a reset signal, and a current value output control circuit which receives the timing edge informations outputted from the respective second selectors, and outputs a synthesis edge having a predetermined current value on the basis of the data set signal, the reset signal, and the output from the RS latch circuit; the data set signal and said reset signal are also input to the parallel processing sequencer; and the parallel processing sequencer controls the timing edge informations so as to be outputted in parallel, according to the inputs of the data set signal and the reset signal.

According to claim 10 of the present invention, in the optical disc device defined in claim 2 or 9, the timer unit is constituted by one timer.

According to claim 11 of the present invention, in the optical disc device defined in claim 2 or 9, the timer unit is constituted by plural timers.

According to claim 12 of the present invention, in the optical disc device defined in claim 2 or 9, the parallel processing sequencer controls the timing edge informations that are successively outputted from the timer unit so that odd and even outputs thereof are outputted in parallel in the order of the respective outputs.

According to claim 13 of the present invention, in the optical disc device defined in claim 2, the parallel processing sequencer is connected to the space/mark length counter unit, performs a counter operation on the basis of an offset of a constant value, and performs sequencer control.

According to claim 14 of the present invention, in the optical disc device defined in claim 1 or 2, the storage unit is constituted by a register.

According to claim 15 of the present invention, in the optical disc device defined in claim 1 or 2, the storage unit has table groups to be stored in tables corresponding to plural recording media of different specifications.

According to claim 16 of the present invention, in the optical disc device defined in claim 1 or 2, data to be written in the storage unit are supplied from an external control device, and the storage unit constitutes the respective table groups from the written data according to need.

According to claim 17 of the present invention, in the optical disc device defined in claim 1 or 2, the clock generation circuit is constituted by a PLL circuit.

According to claim 18 of the present invention, the optical disc device defined in claim 1 or 2 further includes a temperature detection function for detecting the temperature of the recording medium, and adjusting the optical output value of the laser diode driver according to the detected temperature.

According to claim 19 of the present invention, in the optical disc device defined in claim 1 or 2, when signal transmission is performed between at least two semiconductor devices, the signal transmission is carried out using radio wave.

According to claim 20 of the present invention, in the optical disc device defined in claim 1 or 2, the laser power control unit, the write strategy unit, and the laser diode driver are mounted on the same package.

According to claim 21 of the present invention, in the optical disc device defined in claim 1 or 2, the laser power control unit, the write strategy unit, and the laser diode driver are mounted on the same substrate.

According to claim 22 of the present invention, in the optical disc device defined in claim 1 or 2, the laser power control unit, the write strategy unit, and the laser diode driver are stereoscopically mounted one above the other.

### EFFECTS OF THE INVENTION

According to claim 1 of the present invention, in an optical disc device including a laser power control unit which controls power of laser for recording a digital signal sequence on a recording medium, a write strategy unit which divides the recording power and generates a multipulse for accurate pit formation, and a laser diode driver which emits laser according to the multipulse from the write strategy unit, and generating a recording waveform signal having edges and amplitudes corresponding to the digital signal sequence, the write strategy unit comprises a storage unit for storing timing edge informations to be used for generation of edges of the recording waveform signal, a clock generation circuit for generating a clock for generating edges of the recording waveform signal, and a timing control circuit for receiving the timing edge informations corresponding to the recording waveform signal from the storage unit, processing the inputted timing edge informations in parallel, generating edges on the basis of the parallel-processed timing edge informations, and synthesizing the generated edges. Therefore, when performing writing for recording digital information in a recording medium or the like, timing edges can be controlled with high accuracy even during high-speed operation, and thereby a highly-accurate multipulse can be generated.

Further, according to claim 2 of the present invention, in the optical disc device defined in claim 1, the timing control circuit comprises a space/mark length counter unit for receiving the digital signal sequence, and counting a space length and a mark length of the digital signal sequence, a timing sequencer unit for making the storage unit successively output desired timing edge informations on the basis of count values that are counted by the space/mark length counter unit, a timer unit for controlling a delay amount of the clock on the basis of the timing edge informations outputted from the storage unit, and outputting time edge informations having a predetermined delay amount, a parallel processing sequencer for controlling the outputting of the timing edge informations from the timer unit so that the timing edge informations are outputted in parallel, and a parallel processing circuit for generating edges in parallel, on the basis of the parallel-outputted timing edge informations under control of the parallel processing sequencer, and synthesizing the generated edges. Therefore, when performing writing for recording digital information in a recording medium or the like, timing edges can be controlled with high accuracy even during high-speed operation, and thereby a highly-accurate multipulse can be generated.

Further, according to claim 3 of the present invention, in the optical disc device defined in claim 2, the storage unit includes one or plural tables each having a plurality of the timing edge informations, the timing edge informations include address informations corresponding to the count values counted by the space/mark length counter unit, and each table includes table address information corresponding to the table. Therefore, edge informations in accordance with to the space length and the mark length can be obtained.

Further, according to claim 4 of the present invention, in the optical disc device defined in claim 3, the timing sequencer unit controls the outputting of the timing edge informations on the basis of the count values outputted from the space/mark length counter unit, with reference to the table in which the timing edge informations corresponding to the count values are stored. Therefore, desired timing edge informations can be successively outputted from the timer unit according to the operation of the timing sequencer unit.

Further, according to claim 5 of the present invention, in the optical disc device defined in claim 2, when the count value exceeds a predetermined value, the space/mark length counter unit performs a clipping process and outputs a maximum value that has previously been set. Therefore, even when the mark length or the space length is long, the timing sequencer unit can generate desired addresses.

Further, according to claim 6 of the present invention, in the optical disc device defined in claim 2, the timing edge informations stored in the storage unit include at least plural fixed current values, and the recording waveform generated in the parallel processing circuit is a recording waveform a current value of which is selected from among the plural fixed current values stored in the storage unit, according to the mark length and the space length in the section of the mark length. Therefore, a multipulse having a desired current value can be obtained.

Further, according to claim 7 of the present invention, in the optical disc device defined in claim 2, the recording waveform to be generated in the parallel processing circuit has a period for outputting a constant current value to the laser diode driver, between a mark length and a mark length. Therefore, the recording medium can be cooled.

According to claim 8 of the present invention, in the optical disc device defined in claim 2, the timing edge informations inputted to the timer unit include at least delay amounts and current amounts. Therefore, timing edge information having desired delay amounts and desired current amounts can be output from the timer unit.

According to claim 9 of the present invention, in the optical disc device defined in claim 8, the timer unit comprises a plurality of first selectors for parallel outputting the outputs of the timing edge informations having predetermined delay amount values, under selective control of the parallel processing sequencer, and a plurality of second selectors for parallel outputting the outputs of the timing edge informations having predetermined current values, under selective control of the parallel processing sequencer; the parallel processing circuit comprises an RS latch circuit which receives the timing edge informations outputted from the respective first selectors, as a data set signal and a reset signal, and a current value output control circuit which receives the timing edge informations outputted from the respective second selectors, and outputs a synthesis edge having a predetermined current value on the basis of the data set signal, the reset signal, and the output from the RS latch circuit; the data set signal and said reset signal are also input to the parallel processing sequencer; and the parallel processing sequencer controls the timing edge information so as to be outputted in parallel, according to the inputs of the data set signal and the reset signal. Therefore, timing edge informations outputted from plural timers can be processed in parallel, and thereby timing edges can be controlled with high accuracy even during high-speed operation, when performing writing for recording digital data in a recording medium or the like.

According to claim 10 of the present invention, in the optical disc device defined in claim 2 or 9, the timer unit is constituted by a single timer. Therefore, even when using a single timer, timing edges can be controlled with high accuracy.

According to claim 11 of the present invention, in the optical disc device defined in claim 2 or 9, the timer unit is constituted by plural timers. Therefore, even when timing edge informations are outputted at high speed from plural timers, timing edges can be controlled with high accuracy.

According to claim 12 of the present invention, in the optical disc device defined in claim 2 or 9, the parallel processing sequencer controls the timing edge informations that are successively outputted from the timer unit so that odd and even outputs thereof are outputted in parallel in the order of the respective outputs. Therefore, timing edge informations that are outputted from one or plural timers can be processed in parallel.

According to claim 13 of the present invention, in the optical disc device defined in claim 2, the parallel processing sequencer is connected to the space/mark length counter unit, performs a counter operation on the basis of an offset of a constant value, and performs sequencer control. Since the timing edge information is offset by a predetermined delay amount with the timer unit, timing edge informations outputted from one or plural timers can be processed in parallel.

According to claim 14 of the present invention, in the optical disc device defined in claim 1 or 2, the storage unit is constituted by a register. Therefore, desired timing edge informations can be obtained by storing timing edge informations in the register.

According to claim 15 of the present invention, in the optical disc device defined in claim 1 or 2, the storage unit has table groups to be stored in tables corresponding to plural recording media of different specifications. Therefore, timing edge informations appropriate for the specifications of the respective recording media can be stored.

According to claim 16 of the present invention, in the optical disc device defined in claim 1 or 2, data to be written in the storage unit are supplied from an external control device, and the storage unit constitutes the respective table groups from the written data according to need. Therefore, timing edge informations in accordance with a recording waveform signal to be recorded can be output.

According to claim 17 of the present invention, in the optical disc device defined in claim 1 or 2, the clock generation circuit is constituted by a PLL circuit. Therefore, a delay clock for the timer unit can be generated.

According to claim 18 of the present invention, the optical disc device defined in claim 1 or 2 further includes a temperature detection function for detecting the temperature of the recording medium, and adjusting the optical output value of the laser diode driver according to the detected temperature. Therefore, the current value of a cooling pulse can be changed according to the temperature of the recording medium.

According to claim 19 of the present invention, in the optical disc device defined in claim 1 or 2, when signal transmission is performed between at least two semiconductor devices, the signal transmission is carried out using radio wave. Therefore, timing edge informations and the like can be stored through transmission using radio wave.

According to claim 20 of the present invention, in the optical disc device defined in claim 1 or 2, the laser power control unit, the write strategy unit, and the laser diode driver are mounted on the same package. Therefore, the circuit scale can be reduced.

According to claim 21 of the present invention, in the optical disc device defined in claim 1 or 2, the laser power control unit, the write strategy unit, and the laser diode driver are mounted on the same substrate. Therefore, the circuit scale can be further reduced.

According to claim 22 of the present invention, in the optical disc device defined in claim 1 or 2, the laser power control unit, the write strategy unit, and the laser diode driver are stereoscopically mounted one above the other. Therefore, the circuit scale can be further reduced.

### BRIEF DESCRIPTION OF THE DRAWINGS

FIG. 1 is a diagram for explaining an optical disc device according to a first embodiment of the present invention, illustrating a construction for performing write compensation when recording data on a recording medium.

FIG. 2 is a diagram illustrating a construction of a write strategy unit in the optical disc device according to the first embodiment of the present invention.

FIG. 3 is a diagram for explaining a construction of a timing control circuit 24 in the write strategy unit.

FIG. 4 is a conceptual diagram illustrating a space/mark length counter 31.

FIG. 5 is a timing chart illustrating an operation for counting a space length and a mark length in the space/mark length counter.

FIG. 6 is a conceptual diagram for explaining a parallel processing of timing edge informations in the optical disc device according to the first embodiment of the present invention.

FIG. 7 is a timing chart for explaining a parallel processing of timing edge informations in the optical disc device according to the first embodiment of the present invention.

FIG. 8 is a flowchart for explaining an operation of a parallel processing of timing edge informations by an odd/even sequencer in the optical disc device according to the first embodiment of the present invention.

FIG. 9 is a diagram for explaining generation of delay clocks in the optical disc device according to the first embodiment of the present invention.

FIG. 10 is a waveform illustrating a parallel processing of timing edge informations by the odd/even sequencer in the optical disc device according to the first embodiment of the present invention.

FIG. 11 is a timing chart for explaining write compensation by the conventional optical disc device.

### DESCRIPTION OF REFERENCE NUMERALS

11 laser power controller
12 write strategy unit
13 laser diode driver
21 serial/parallel conversion circuit
22 control register
23 PLL unit
24 timing control circuit
25 logic control circuit
31 space/mark length counter
32 timing sequencer
33 odd/even sequencer
34 timer
35 parallel processing circuit
41 digital signal sequence
42 mark detection signal
43 space detection signal
44 space counter
45 mark counter
46,47,48 registers
49 mark edge
50 count value of space length 1
51 counter value of space length 0
52 count value of mark length 0
53 reset signal
72,72,73,74 selectors
75 RS latch circuit
76 current value output control circuit
110 period wherein two edges are generated in one clock section
S1 timing edge information
S2 parallel-converted timing edge information
S3 clock
S4 NRZI data
S5 PLL output
S6 address pointer
S7 timing edge information outputted from control register
S8 Mode signal
S9 synthesis edge
S10 counter value
S11 counter output
S12 count information
S13 selector signal
S14 timing edge information outputted from timer
S15 data set signal, data reset signal
S61 data set signal to be input to current value output control circuit
S62 reset signal to be input to current value output control circuit
S63 RSout

### BEST MODE TO EXECUTE THE INVENTION

Hereinafter, an embodiment of the present invention will be described with reference to the drawings.

### Embodiment 1

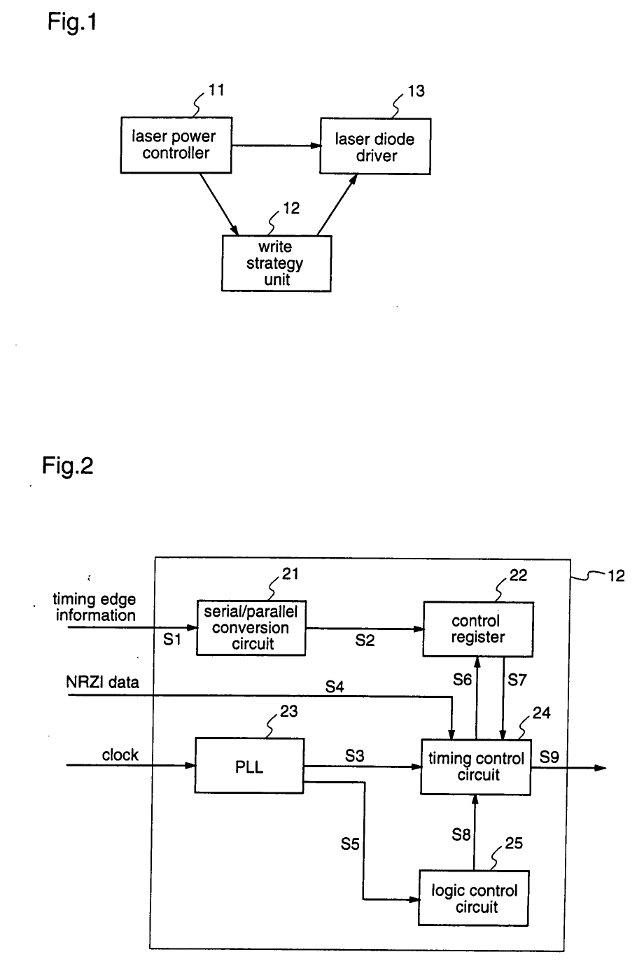

FIG. 1 is a diagram for explaining an optical disc device according to a first embodiment of the present invention, illustrating a construction for performing write compensation when recording data on a recording medium.

With reference to FIG. 1, a laser power controller (LPC) 11 controls power of laser for recording, a write strategy unit (WST) 12 divides the recording power to generate a multipulse for accurate pit formation, and a laser diode driver (LDD) 13 emits laser according to the multipulse from the write strategy unit.

Next, the write strategy unit 12 in the optical disc device according to the first embodiment will be described.

FIG. 2 is a diagram illustrating the construction of the write strategy unit in the optical disc device according to the first embodiment.

With reference to FIG. 2, the write strategy unit 12 comprises a serial/parallel conversion circuit 21 for parallel converting timing edge information S1 which is serially inputted and indicates such as a delay of a timing edge for generating an edge of a recording waveform signal to be recorded and a current value of laser, a control register 22 for holding the parallel-converted timing edge information S2, a PLL (Phase Locked Loop) unit 23 for generating a clock S3 of a predetermined period, a timing control circuit 24 for performing synthesis of edges on the basis of digital data (NRZI) S4 supplied from the outside and the timing edge information S7 from the control register 22 to output a synthesis edge S9, and a logic control circuit 25 for performing write control to the control register. The control register may be provided in the timing control circuit 24, or plural control registers may be provided.

Further, timing edge information S2 such as plural delay amounts and plural current values of laser which are needed for edge synthesis is written in the control register 22 from the outside through the serial/parallel conversion circuit 21, and a table group is constituted as needed from the written data, and a plurality of timing informations are stored in each table. The table group is written in tables corresponding to specifications of recording media, such as CD-RW, DVD-R, DVD-RAM, Blu-ray (trademark), whereby table groups suited to the respective recording media are constituted. Further, the respective tables and timing edge informations which are written in the control register 22 have corresponding addresses, and desired timing edge information is outputted according to an address pointer S6 that is outputted from the timing control circuit 24.

The timing control circuit 24 receives the timing edge information S7 outputted from the control register 22, and processes the inputted timing edge information in parallel, and then performs edge synthesis.

Further, the logic control circuit 25 performs access control to the register, generates a Mode signal S8, and writing to the register is not performed when the Mode signal is “1”. That is, the logic control circuit 25 performs control so that no data conflict occurs during data writing and reading. The Mode signal becomes “1” when conditions satisfied by a combination of various control signals such as a signal S5 generated in the PLL circuit 23.

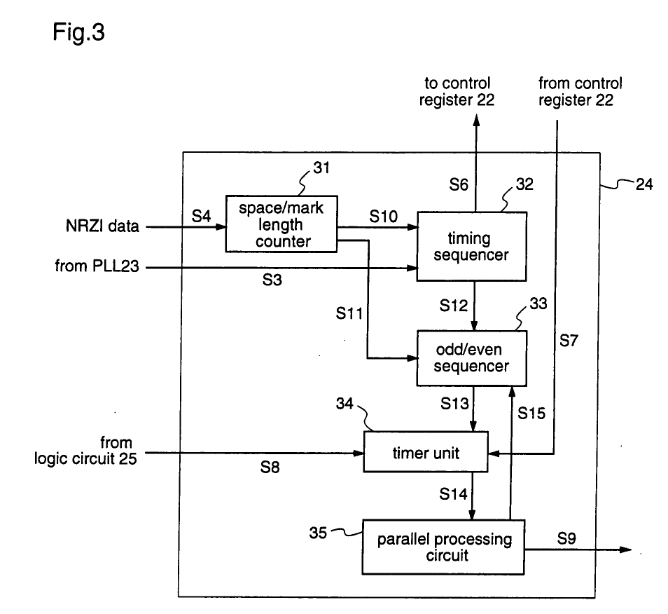

FIG. 3 is a diagram illustrating the construction of the timing control circuit 24.

In FIG. 3, the timing control circuit 24 comprises a space/mark length counter 31 for counting pattern sequences of a space length and a mark length of NRZI data S4 which is externally inputted digital data, a timing sequencer 32 for generating an address pointer S6 for the control register on the basis of a count value S10 from the space/mark length counter 31, a timer unit 34 for outputting timing edge information S14 having predetermined delay amount and current value on the basis of the timing edge information S7 outputted from the control register 22 according to the output of the timing sequencer 32, an odd/even sequencer 33 for controlling the output of the timing edge information S14 that is sequentially outputted from the timer unit 34 so that odd and even outputs thereof are outputted in parallel in the order of the respective outputs, and a parallel processing circuit 35 for generating edges in parallel on the basis of the timing edge information that is outputted in the order of the respective odd and even outputs under control of the odd/even sequencer 33, and synthesizes the generated edges to output a synthesis edge S9. In this first embodiment, the timer unit 34 includes four timers.

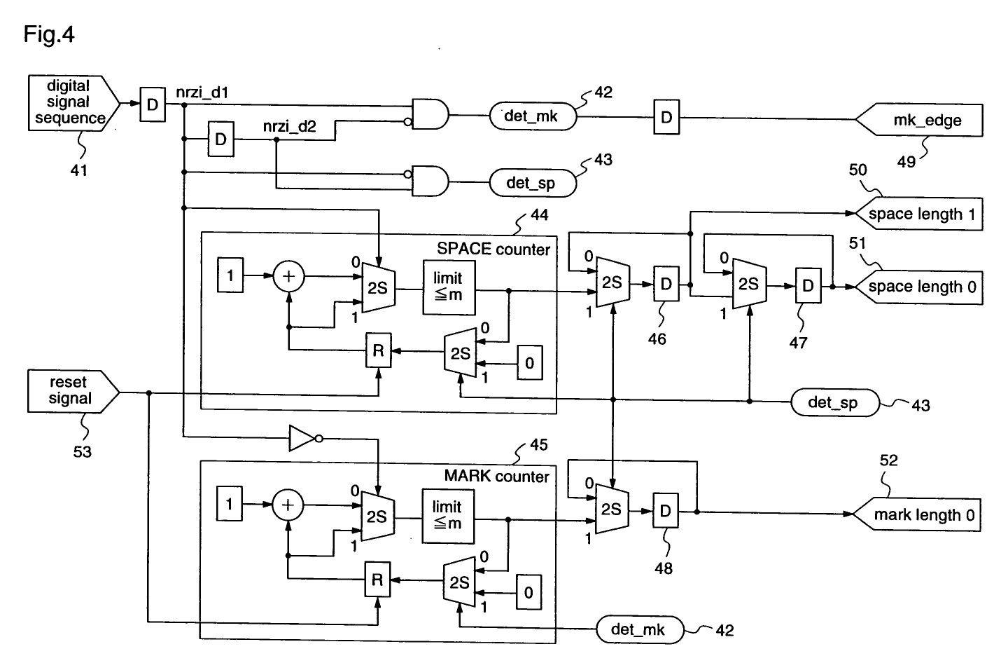

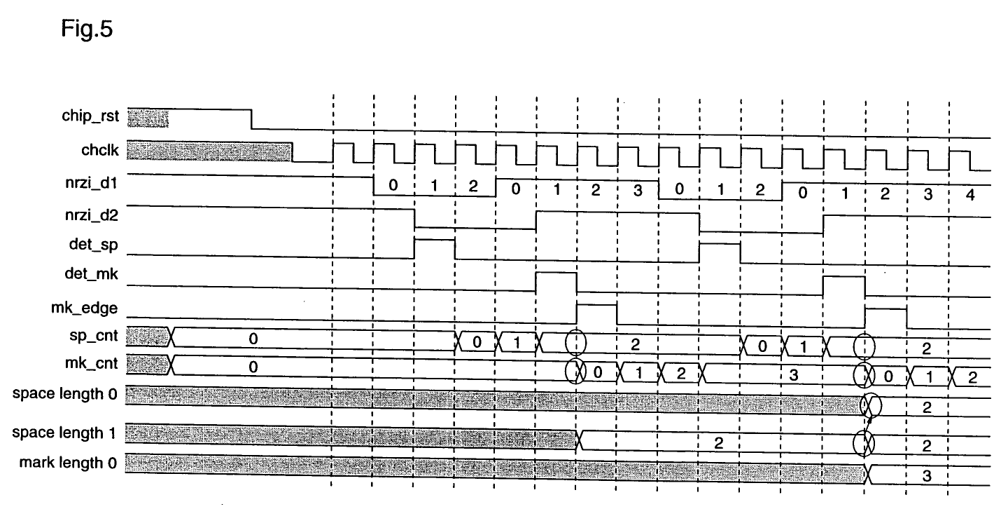

Next, the space/mark length counter will be described in detail with reference to FIGS. 4 and 5.

FIG. 4 is a conceptual diagram illustrating the count operation of the space/mark length counter 31, and FIG. 5 is a timing chart illustrating an operation of detecting a space length and a mark length.

In the space/mark length counter shown in FIG. 4, a rising edge and a falling edge of the inputted NRZI data 41 are detected to perform count operation. That is, assuming that the NRZI data synchronized with a clock is “10001111000001”, counting of a space length starts from transition of 1→0, i.e., a falling edge, and counting of a mark length starts from transition of 0→1, i.e., a rising edge. When there is a count exceeding a predetermined value, it is clipped, and a maximum value is outputted.

Further, in FIG. 4, the space/mark length counter 31 uses digital signal sequences nrzi_d1 and nrzi_d2 having a difference of one clock, thereby enabling space detection and mark detection.

Initially, when the space counter 44 detects a space from the digital signal sequence 41, a reset signal 53 becomes effective and thereby a count value (sp_cnt) is reset, and the space counter 44 starts to count the space length at a falling edge of a space detection signal (det_sp) 43 as shown in FIG. 5. The space counter 44 continues the counting until it detects a mark from the digital signal sequence 41. When the space counter 44 detects a mark, the counted space length is regarded as space length 1, and “2” as the count value (sp_cnt) is stored in the register 46.

When the mark counter 45 detects a mark from the digital signal sequence 41, a reset signal 53 becomes effective and thereby a count value (mk_cnt) is reset, and the mark counter 45 starts to count the mark length at a falling edge of a mark detection signal (det_mk) 42 as shown in FIG. 5. The mark counter 45 continues the counting until it detects a space from the digital signal sequence 41. When the mark counter 45 detects a space, the counted mark length is regarded as mark length 0, and “3” as the count value (mk_cnt) is stored in the register 48.

When the space counter 44 detects a space from the digital signal sequence 41, initially, the space length 1 that is stored in the register 46 is stored as space length 0 in the register 47. Then, the reset signal 53 becomes effective and thereby the count value (sp_cnt) is reset, and the space counter 44 starts to count the space length at a falling edge of the space detection signal (det_sp) as shown in FIG. 5. Then, the space counter 44 continues the counting until it detects a mark from the digital signal sequence 41. When the space counter 44 detects a mark, the counted space length is regarded as space length 1, and “2” as the count value (sp_cnt) is stored in the register 46. That is, in order to obtain the count values in a pattern of space—mark—space, the count value of the space length that is counted earlier in time sequence is regarded as space length 0 while the count value (sp_cnt) of the space length that is counted later is regarded as space length 1.

Further, the space/mark counter 31 outputs a mark edge (mk_edge) indicating that a mark is detected.

In this way, the space/mark length counter counts the space length 0 (51), the mark length 0 (52), and the space length 1 (50), and outputs the count values and the mark edge (mk_edge) 49 to the timing sequencer 32 and to the odd/even sequencer 33.

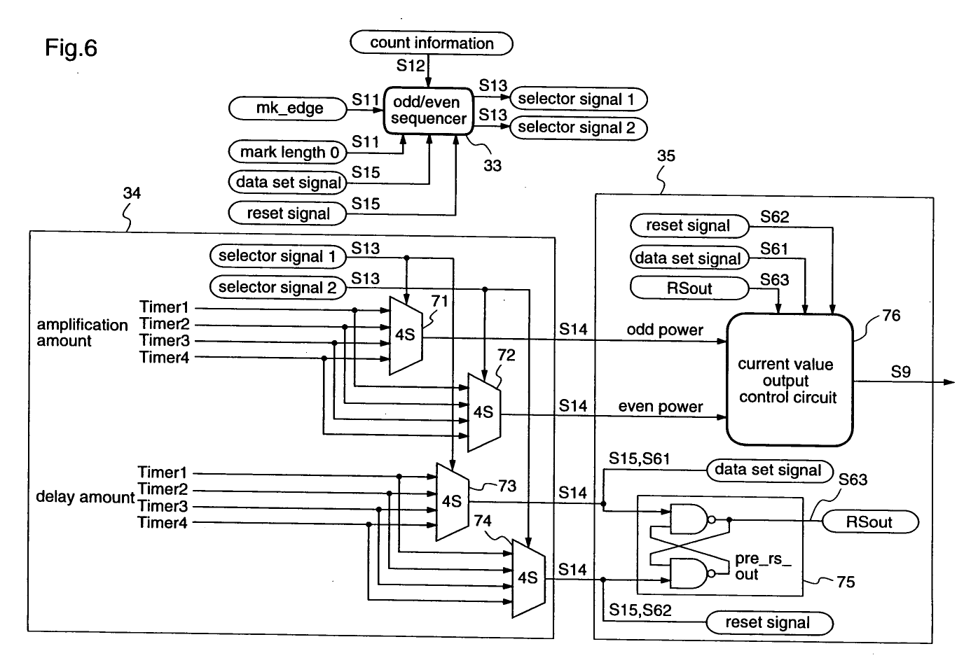

Next, the parallel processing for the timing edge information which is performed by the parallel processing circuit 35 will be described in detail with reference to FIG. 6.

FIG. 6 is a conceptual diagram illustrating the parallel processing for the timing edge information in the optical disc device according to the first embodiment.

In FIG. 6, the odd/even sequencer 33 receives the mark edge (mk_edge) and the count value of mark length 0 which are outputted from the space/mark length counter 31, and a data set signal and a data reset signal which will be described later, and outputs a selector signal 1 and a selector signal 2 for parallel processing the timer operation.

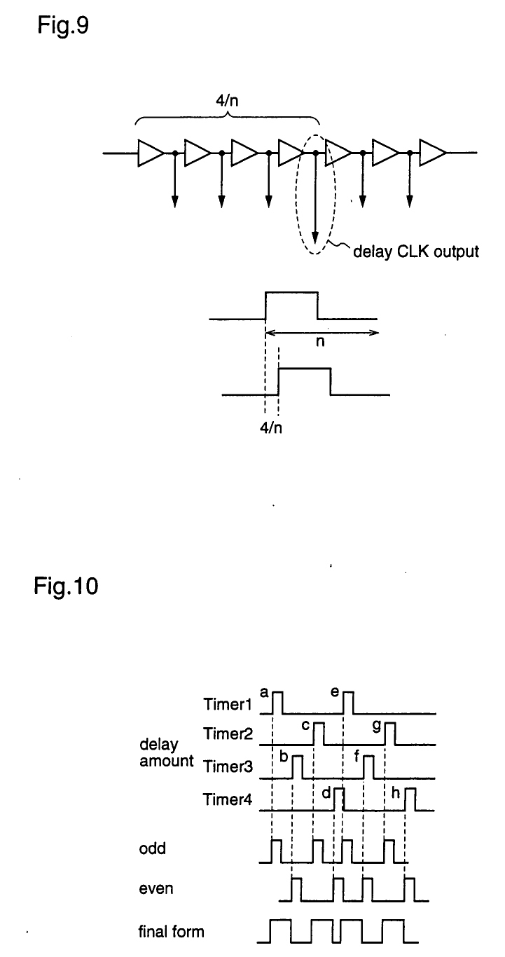

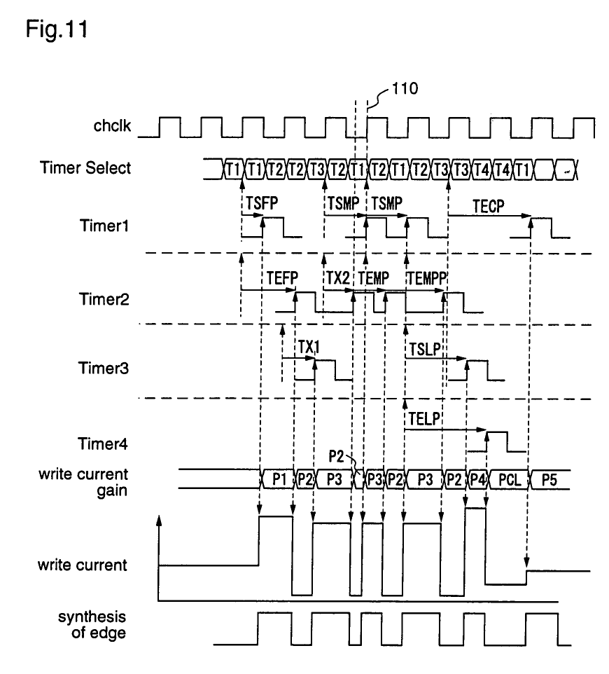

The timer unit 34 is provided with selectors 71 to 74, each selecting one of timer outputs from the four timers (Timer 1 to Timer 4) according to selector signals S13 outputted from the odd/even sequencer 33, and timing edge information that has a predetermined current amplification amount and is delayed by a predetermined delay amount is outputted from the selected timer. In this way, each timer delays the timing edge information synchronized with the clock by a predetermined delay amount that is supplied from the control register 22, thereby outputting a signal S14. At this time, since the delay amount to be initially outputted is determined by the address pointer S6 generated by the timing sequencer 32, a delay clock is generated from this delay amount. For example, the delay amounts in the respective timers can be generated by a delay clock generation circuit comprising n (n: natural number) stages of shift registers as shown in FIG. 9. For example, when the delay amount is 4, it means 4/n delay.

The selector 71 outputs the current amplification amount of the timing edge information of the odd output in the outputting order of the timing edge informations that are successively outputted by the respective timer operations, the selector 72 outputs the current amplification amount of the timing edge information of the even output in the outputting order of the timing edge informations that are successively outputted by the respective timer operations, the selector 73 outputs the timing edge information which has a predetermined delay amount value and is the odd output in the outputting order of the timing edge informations that are successively outputted by the respective timer operations, and the selector 74 outputs the timing edge information which is delayed by a predetermined delay amount value and is the even output in the outputting order of the timing edge informations that are successively outputted by the respective timer operations.

The parallel processing circuit 35 has an RS latch circuit 75 and a current value output control circuit 76. The RS latch circuit 75 outputs RSout, with the timing edge information S14 from the selector 73 which is the odd output in the outputting order of the timing edge informations outputted from the timer unit 34 being a data set signal, and the timing edge information S14 from the selector 74 which is the even output in the outputting order of the timing edge informations outputted from the timer unit 34 being a data reset signal. Further, the data set signal and the data reset signal are outputted to the odd/even sequencer 33 as signals S15 indicating the odd output and the even output, respectively, and further, they are outputted to the current value output control circuit 76. The RSout is outputted to the current value output control circuit 76. The current value output control circuit 76 receives the data set signal, the reset signal, and the RSout which are outputted from the Rs latch circuit 75, and receives the current amplification amount from the selector 71 which is the odd output, and the current amplification amount from the selector 72 which is the even output, and outputs a synthesis edge having a controlled current value. In this way, the plural timing edges can be parallel processed.

FIG. 10 is a diagram illustrating timer control according to the first embodiment of the present invention.

Initially, when the timing edge information of the Timer 1 is outputted, a data set signal is output, and a timing edge “a” indicating an odd output in the output order of the timing information rises. When the timing edge information of the Timer 3 which is the next output in the output order is outputted, a reset signal is outputted, whereby a timing edge “b” indicating an even output in the output order of the timing information. Thereby, a final-form synthesis edge is generated from the current value output control circuit 76, and thereafter, this operation is repeated for timing edges “c”˜“h”, thereby generating synthesis edges having predetermined current amplification amounts.

Next, the operation of the optical disc device according to the first embodiment will be described.

Initially, timing edge information S1 for generating edges of recording waveform information to be recorded is parallel converted by the serial/parallel conversion circuit 21, and stored in the control register 22. Then, the space/mark length counter 31 receives NRZI data S4, and counts a space length and a mark length. The timing sequencer 32 sequentially outputs an address pointer S6 corresponding to the count value S10 counted by the space/mark length counter 31 to the control register 22, and the control register 22 sequentially outputs the timing edge information S7 according to the address pointer S6 that is sequentially outputted from the timing sequencer 32 to the corresponding timer. When the timing sequencer 32 performs sequencer control in this way, the timing sequencer 32 refers to the table stored in the control register 22, whereby the timing edge information corresponding to the count values of the space length and the mark length is outputted from the control register 22. Then, each timer controls the delay amount on the basis of the timing edge information S7 from the control register 22, and outputs the timing edge information S14 having a predetermined delay amount. That is, the output order of the timing edge information to be outputted from the respective timers is controlled by the timing sequencer 32 through the control register 22, and the timing edge informations are successively outputted from the respective timers according to the output of the timing sequencer 32.

Then, the odd/even sequencer 33 controls the selectors 71 to 74 to control the outputs of the timing edge information S14 which are successively outputted from the respective timers so that the odd and even outputs thereof are outputted in parallel in the order of the respective outputs, and the current value output control circuit 76 outputs a synthesis edge S9 from the parallel-inputted timing edge information.

Next, the operation of parallel processing the timing edge information and synthesizing the edges in the optical disc device according to the first embodiment will be described with reference to FIGS. 6 to 8.

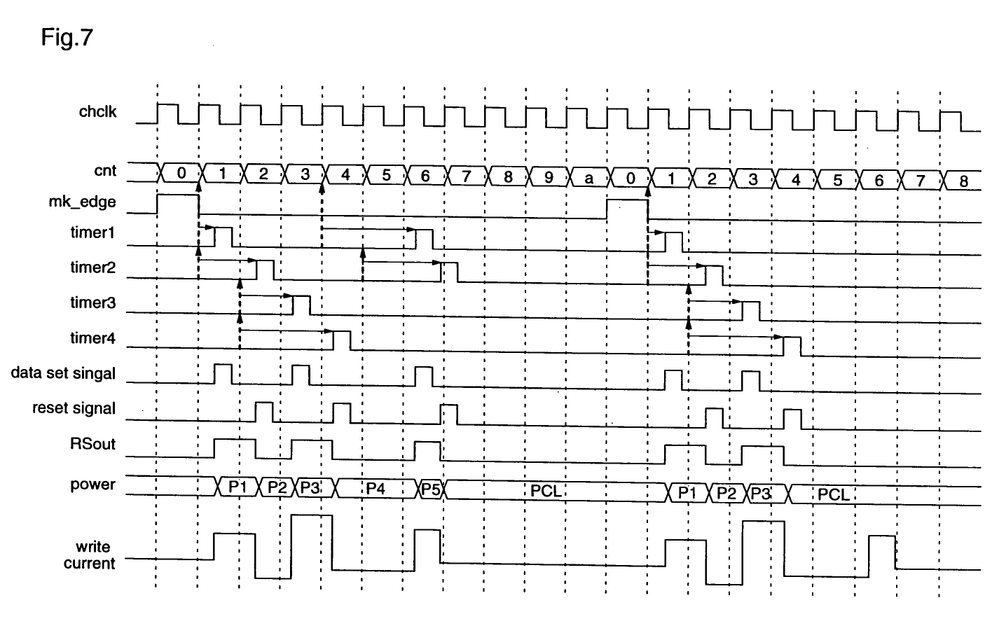

FIG. 7 is a timing chart illustrating edge synthesis by the optical disc device according to the first embodiment.

In FIG. 7, a count value (cnt) that is counted in synchronization with a clock is a value counted by the odd/even sequencer 33, and this value is used for generating an enable signal that indicates which timing each of the timers, i.e., Timer 1 to Timer 4, should be operated. This value (which drives the timer) is predetermined according to the output S12 from the timing sequencer 32. The respective timers, Timer 1 to Timer 4,. perform predetermined delay operations, and the outputs thereof are selected by the selectors 71 to 74 and outputted to the parallel processing circuit 35.

Further, P1 to P5 denote the current values of the timing edge information. In “write current” indicating the amplitudes of the current values, a predetermined level of write current exists in a section between a mark length and a mark length. This is a period for cooling the medium, which is called a cooling pulse (PCL), and it is a constant write current. Further, since the laser driving changes momentarily due to the temperature characteristics of the medium, a temperature detection function for detecting the temperature of the recording medium and automatically controlling the optical output value from the laser diode driver according to the detected temperature may be provided, whereby the current value of the cooling pulse can be varied.

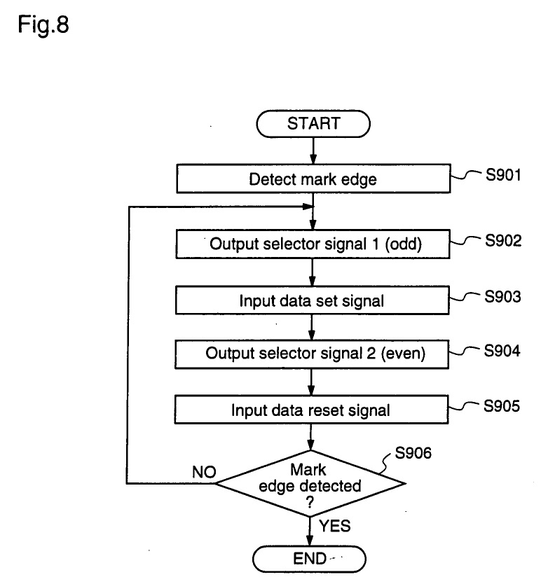

FIG. 8 is a flowchart illustrating the operation of controlling the timing edge information from the respective timers so as to be outputted in parallel by using the odd/even sequencer 33.

When the odd/even sequencer 33 receives a mark edge (mk_edge) from the space/mark length counter 31 (step S901), initially, it outputs a selector signal 1 indicating an odd output according to a predetermined count timing (step S902). Then, the selector signal 1 (S13) is inputted to the selectors 71 and 73, and timing edge information S14 having predetermined current value and delay amount is outputted from any of the Timer 1 to Timer 4 to the parallel processing circuit 35.

In the parallel processing circuit 35, a predetermined current amplification amount is supplied from the selector 71 to the current value output control circuit 76, and the timing edge information that is delayed by a predetermined delay amount is supplied from the selector 73 to the RS latch circuit 75 as a data set signal. Further, the data set signal is outputted as S15 to the odd/even sequencer 33 while it is outputted as S61 to the current value output control circuit 76.

Next, when the odd/even sequencer 33 receives the data set signal S15 (step S903), it outputs a selector signal 2 (S13) indicating an odd output according to a predetermined count value (step S904). Then, the selector signal 2 is inputted to the selectors 72 and 74, and timing edge information S14 having predetermined current value and delay amount is outputted from any of the Timer 1 to Timer 4 to the parallel processing circuit 35.

In the parallel processing circuit 35, a predetermined current amplification amount from the selector 72 is inputted to the current value output control circuit 76, and the timing edge information that is delayed by a predetermined delay amount is outputted from the selector 74 as a reset signal to the RS latch circuit 75 (step S905). The reset signal is outputted as S15 to the odd/even sequencer 33, and further, it is outputted as S61 to the current value output control circuit 76. At this time, the RSout (S63) as an output from the RS latch circuit 75 is outputted to the current value output control circuit 76.

The odd/even sequencer 33 repeats the above-mentioned operation for the period of mark length 0 (S11), and when a mark edge S11 is detected (step S906), it is judged that edge synthesis for one mark is completed, and thereby the count value is reset and edge synthesis for a next mark is carried out. As a result, a synthesis edge S9 having a predetermined current amplification amount is generated from the current value output control circuit 76.

As described above, according to the first embodiment of the present invention, in the optical disc device including a laser power control unit 11 which controls power of laser for recording a digital signal sequence on a recording medium, a write strategy unit 12 which divides the recording power and generates a multipulse for accurate pit formation, and a laser diode driver 13 which emits laser according to the multipulse from the write strategy unit, and generating a recording waveform signal having edges and amplitudes corresponding to the digital signal sequence, the write strategy unit 12 comprises a control register 22 for storing timing edge information to be used for generation of edges of the recording waveform signal, a PLL 23 for generating a clock for generating edges of the recording waveform signal, and a timing control circuit 24 for receiving the timing edge information corresponding to the recording waveform signal from the control register 22, parallel-processing the inputted timing edge information, and performing synthesis of the parallel-processed timing edge information. In the timing control circuit 24, a space/mark length counter 31 counts a space length and a mark length of the digital signal sequence, a timing sequencer 32 makes the control register 22 output desired timing edge information on the basis of the count value, the outputs from the respective timers, Timer 1 to Timer 4, are outputted in parallel in the output orders of odd outputs and even outputs, respectively, by an odd/even sequencer 33, and a parallel processing circuit 35 generates edges on the basis of the parallel-outputted timing edge information and synthesizes the generated edges. Therefore, when writing a signal in a medium or the like which stores digital information, timing edges can be controlled with high accuracy even during high-speed operation.

While in the optical disc device according to the first embodiment the timer 34 comprises four timers, the present invention is not restricted thereto, and the present invention is effective even when one or plural timers is/are used.

Further, in the optical disc device according to the first embodiment, two timing edge information outputs are parallel processed according to the output orders of odd outputs and even outputs of the timing edge informations that are successively outputted from the timers. However, the present invention is not restricted thereto, and more than two timing edge information outputs may be parallel processed. Further, the outputs of the respective timers may be respectively parallel processed.

Furthermore, while the optical disc device according to the first embodiment adopts the control register 22, the present invention is not restricted thereto, and a storage device such as a RAM (Random Access Memory) may be adopted.

Furthermore, in the optical disc device according to the first embodiment, the laser power controller 11, the write strategy unit 12, and the laser diode driver 13 may be constituted on the same package such as a SoC (System on Chip), thereby reducing the circuit scale.

Furthermore, in the optical disc device according to the first embodiment, the laser power controller 11, the write strategy unit 12, and the laser diode driver 13 may be constituted on the same substrate, thereby further reducing the circuit scale.

Furthermore, in the optical disc device according to the first embodiment, the laser power controller 11, the write strategy unit 12, and the laser diode driver 13 may be stereoscopically constituted. For example, the device of the laser diode driver is mounted beneath the write strategy unit 12, and the laser power controller 11 is disposed beneath the laser diode driver, thereby further reducing the circuit scale.

Furthermore, in the optical disc device according to the first embodiment, when signal transmission is performed between at least two devices, the signal transmission may be performed using radio wave.

### APPLICABILITY IN INDUSTRY

An optical disc device according to the present invention has a digital signal processing technique, and it is useful as such as a DVD device in a recording/reproduction technique.

1. (canceled)

2. An optical disc device including a laser power control unit which controls power of laser for recording a digital signal sequence on a recording medium, a write strategy unit which divides the recording power and generates a multipulse for accurate pit formation, and a laser diode driver which emits laser according to the multipulse from the write strategy unit, said optical disc device generating a recording waveform signal having edges and amplitudes corresponding to the digital signal sequence, wherein
said write strategy unit comprises:
a storage unit for storing timing edge informations to be used for generation of edges of the recording waveform signal;
a clock generation circuit for generating a clock for generating edges of the recording waveform signal; and
a timing control circuit for receiving the timing edge informations corresponding to the recording waveform signal from the storage unit, processing the inputted timing edge informations in parallel, generating edges on the basis of the parallel-processed timing edge informations, and synthesizing the generated edges; and
said timing control circuit comprises:
a space/mark length counter unit for receiving the digital signal sequence, and counting a space length and a mark length of the digital signal sequence;
a timing sequencer unit for making the storage unit successively output desired timing edge informations on the basis of a count value that is counted by the space/mark length counter unit;
a timer unit for controlling a delay amount of the clock on the basis of the timing edge informations outputted from the storage unit, and outputting time edge informations having a predetermined delay amount;
a parallel processing sequencer for controlling the outputting of the timing edge informations from the timer unit so that the timing edge informations are outputted in parallel; and
a parallel processing circuit for generating edges in parallel on the basis of the parallel-outputted timing edge informations under control of the parallel processing sequencer, and synthesizing the generated edges.

3. An optical disc device as defined in claim 2 wherein
said storage unit includes one or plural tables each having a plurality of the timing edge informations;
said timing edge informations include address informations corresponding to the count values counted by the space/mark length counter unit; and
each table includes table address information corresponding to the table.

4. An optical disc device as defined in claim 3 wherein said timing sequencer unit controls outputting of the timing edge informations on the basis of the count values outputted from the space/mark length counter unit, with reference to the table in which the timing edge informations corresponding to the count values are stored.

5. An optical disc device as defined in claim 2 wherein, when the count value exceeds a predetermined value, said space/mark length counter unit performs a clipping process and outputs a maximum value that has previously been set.

6. An optical disc device as defined in claim 2 wherein
the timing edge informations stored in the storage unit include at least plural fixed current values; and
the recording waveform generated in the parallel processing circuit is a recording waveform a current value of which is selected from among the plural fixed current values stored in the storage unit, according to the mark length and the space length in the section of the mark length.

7. An optical disc device as defined in claim 2 wherein the recording waveform to be generated in the parallel processing circuit has a period for outputting a constant current value to the laser diode driver, between a mark length and a mark length.

8. An optical disc device as defined in claim 2 wherein the timing edge informations inputted to the timer unit include at least delay amounts and current amounts.

9. An optical disc device as defined in claim 8 wherein
said timer unit comprises:
a plurality of first selectors for parallel outputting the outputs of the timing edge informations having predetermined delay amount values, under selective control of the parallel processing sequencer, and
a plurality of second selectors for parallel outputting the outputs of the timing edge informations having predetermined current values, under selective control of the parallel processing sequencer;
said parallel processing circuit comprises:
an RS latch circuit which receives the timing edge informations outputted from the respective first selectors, as a data set signal and a reset signal, and
a current value output control circuit which receives the timing edge informations outputted from the respective second selectors, and outputs a synthesis edge having a predetermined current value on the basis of the data set signal, the reset signal, and the output from the RS latch circuit;
said data set signal and said reset signal are also input to the parallel processing sequencer; and
said parallel processing sequencer controls the timing edge informations so as to be outputted in parallel, according to the inputs of the data set signal and the reset signal.

10. An optical disc device as defined in claim 2 wherein said timer unit is constituted by one timer.

11. An optical disc device as defined in claim 2 wherein said timer unit is constituted by plural timers.

12. An optical disc device as defined in claim 2 wherein said parallel processing sequencer controls the timing edge informations that are successively outputted from the timer unit so that odd and even outputs thereof are outputted in parallel in the order of the respective outputs.

13. An optical disc device as defined in claim 2 wherein said parallel processing sequencer is connected to the space/mark length counter unit, performs a counter operation on the basis of an offset of a constant value, and performs sequencer control.

14. (canceled)

15. (canceled)

16. (canceled)

17. (canceled)

18. (canceled)

19. (canceled)

20. (canceled)

21. (canceled)

22. (canceled)

23. An optical disc device as defined in claim 9 wherein said timer unit is constituted by one timer.

24. An optical disc device as defined in claim 9 wherein said timer unit is consituted by plural timers.

25. An optical disc device as defined in claim 9 wherein said parallel processing sequencer controls the timing edge informations that are successively outputted from the timer unit so that odd and even outputs thereof are outputted in parallel in the order of the respective outputs.
